(19) United States
(12) Patent Application Publication
(10) Pub. No.: US 2009/0091154 A1
(43) Pub. Date: Apr. 9, 2009

(54) Positioning Structure of Sunshade

(76) Inventor: Jing-Shyong Gong, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/866,438

(22) Filed: Oct. 3, 2007

(51) Int. Cl. B60J 3/00

(52) U.S. Cl. 296/97.9

(57) ABSTRACT

A positioning structure of a sunshade has upper positioning blocks each having a surface attached to a flexible sheet via a double-sided adhesive and another surface with an opening having a width smaller than that of a flexible member wound in a peripheral edge of the sunshade, and lower positioning blocks each having a surface attached to a double-sided adhesive and another surface with an opening having a width equal to or slightly greater than that of the flexible member. The positioning blocks are then precisely mounted on uneven upper and lower flanges of a vehicle window frame. One side of the sunshade is inclinedly inserted into the openings of the upper positioning blocks, and an opposite side thereof is directly inserted into the openings of the lower positioning blocks, so as to provide an operational flexibility to stably hold the sunshade.

### FIELD OF THE INVENTION

The present invention relates to a positioning structure of a sunshade, and more particularly to the positioning structure having an upper positioning block and a lower positioning block, both of which are respectively mounted on an uneven upper flange and an uneven lower flange of a window frame of a vehicle for positioning the sunshade, wherein the upper positioning block is attached to a flexible sheet for being stably mounted on the upper flange of the window frame, and the lower positioning block is attached to a double-sided adhesive for being stably mounted on the lower flange of the window frame, so that the upper and lower positioning blocks can be used to hold and position the sunshade.

### BACKGROUND OF THE INVENTION

Generally, the outdoor temperature is generally high in summer. For a vehicle, it may be provided with an air conditioner therein, but the strong sunlight and the ultraviolet radiation thereof still trouble a driver of the vehicle. To solve the foregoing problem, related manufacturers developed various sunshade products, such as an electrostatic sticker capable of being attached to a vehicular window, and a sucker-type sunshade capable of being adhered to the vehicular window, for consumers to suitably select according to his/her favorite. However, said sunshade products are simple, and directly attached to the vehicular window. Thus, when the vehicular window is shifted downward, the sunshade products must be taken off in advance, resulting in an operational inconvenience of the consumers.

### SUMMARY OF THE INVENTION

It is therefore tried by the inventor to develop a positioning structure of a sunshade to improve the conventional sunshade products developed by the related manufacturers, wherein the positioning structure comprises an upper positioning block and a lower positioning block which can be suitably mounted on an upper flange and a lower flange of a window frame on two sides of various vehicles, for the purpose of stably holding the sunshade therebetween, enhancing the positioning strength of the upper and lower positioning blocks, and providing an operational flexibility.

A primary object of the present invention is to provide the positioning structure of a sunshade, which comprises the upper positioning block and the lower positioning block for positioning the sunshade, wherein the upper positioning block has a surface attached to a flexible sheet via a double-sided adhesive and another surface formed with an opening providing a width permanently smaller than that of a flexible member wound in a peripheral edge of the sunshade, while the lower positioning block has a surface attached to a double-sided adhesive and another surface formed with an opening providing a width equal to (or slightly greater than) that of the flexible member wound therein. As a result, the upper and lower positioning blocks can be precisely mounted on an uneven upper flange and an uneven lower flange of a window frame on two sides of a vehicle for holding the sunshade therebetween. In operation, one side of the sunshade is firstly inclinedly inserted into the opening of the upper positioning block, and then an opposite side thereof is directly inserted into the opening of the lower positioning block, so that the upper and lower positioning blocks can provide an operational flexibility to stably hold the sunshade on various different window frames.

### BRIEF DESCRIPTION OF THE DRAWINGS

The structure and the technical means adopted by the present invention to achieve the above and other objects can be best understood by referring the following detailed description of the preferred embodiments and the accompanying drawings, wherein:

FIG. 1 is an exploded perspective view of a positioning structure of a sunshade according to a preferred embodiment of the present invention;

FIG. 2 is a cross-sectional view of an upper positioning block mounted on an upper flange of a window frame of a vehicle according to the preferred embodiment of the present invention;

FIG. 3 is a cross-sectional view of a lower positioning block mounted on a lower flange of the window frame of the vehicle according to the preferred embodiment of the present invention;

FIG. 4 is a cross-sectional view of a first end of the sunshade inserted into an opening of the upper positioning block according to the preferred embodiment of the present invention; and

FIG. 5 is a cross-sectional view of a second end of the sunshade inserted into an opening of the lower positioning block according to the preferred embodiment of the present invention.

### DETAILED DESCRIPTION OF THE PREFERRED EMBODIMENTS

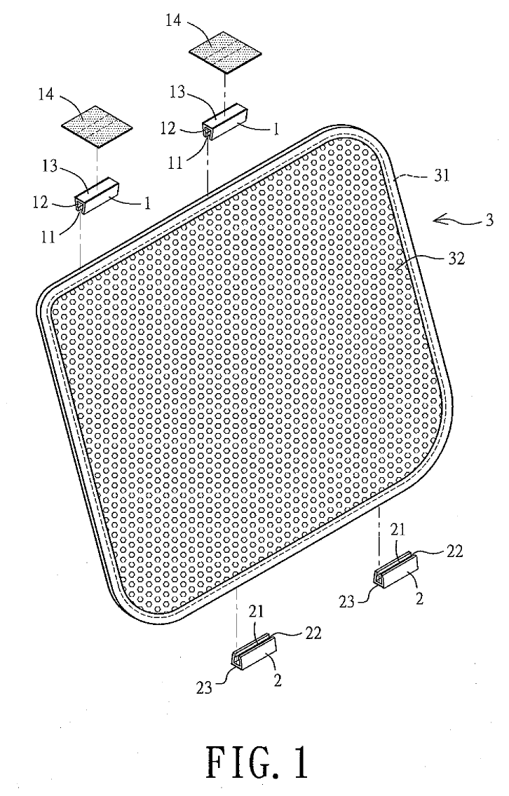

Referring now to FIG. 1, a positioning structure of a sunshade according to a preferred embodiment of the present invention is illustrated. As shown, the positioning structure comprises upper positioning blocks 1, lower positioning blocks 2, and the sunshade 3 having a peripheral edge wound with a flexible member 31 thereon.

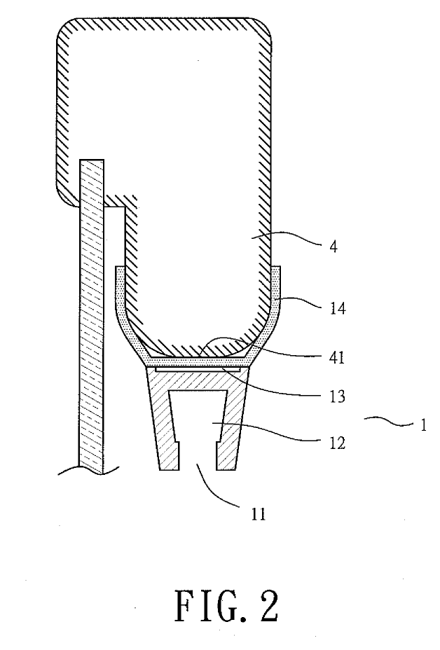

Referring now to FIGS. 1 and 2, the upper positioning block 1 has a surface attached to a flexible sheet 14 via a double-sided adhesive 13 and another surface formed with an opening 11 providing a width permanently smaller than that of the flexible member 31 wound in the peripheral edge of the sunshade 3. The opening 11 of the upper positioning block I is extended inward to form a receiving space 12 which is shaped in tapered off to an outer edge of the opening 11. The flexible sheet 14 has an adhesive surface away from the upper positioning block 1, and the adhesive surface is provided with a release film (not shown). (In use, the release film can be peeled off, so that the flexible sheet 14 will be attached to the upper flange of the window frame of the vehicle by the adhesive surface.)

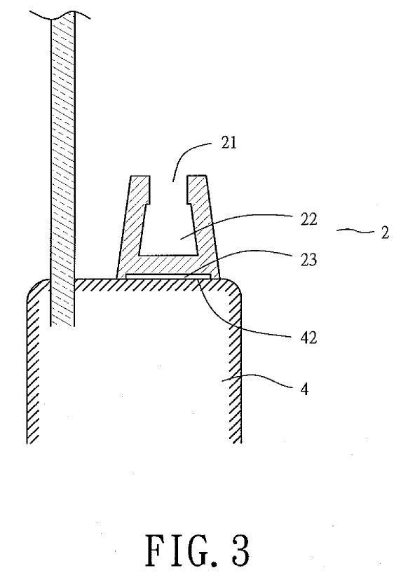

Referring now to FIGS. 1 and 3, the lower positioning block 2 has a surface attached to a double-sided adhesive 23 and another surface formed with an opening 21 providing a width equal to (or slightly greater than) that of the flexible member 31 wound in the peripheral edge of the sunshade 3. Meanwhile, the opening 21 of the lower positioning block 2 is extended inward to form a receiving space 22 shaped in tapered off to an outer edge of the opening 21.

Referring back to FIG. 1, the sunshade 3 is a curtain fabric 32 shaped according to the shape of the window frame of various vehicles. The peripheral edge of the curtain fabric 32 is provided with the flexible member 31 made of a tough material therein.

Referring to FIGS. 2 and 3, when the upper and lower positioning blocks 1, 2 are mounted on window frames 4 of two sides of the vehicle, the release film (not shown) on an adhesive outer surface of the flexible sheet 14 of the upper positioning block 1 can be firstly peeled off, so that the upper positioning block 1 can be precisely attached to and positioned on an uneven upper flange 41 of the window frame 4. Then, a release film (not shown) on an outer surface of the double-sided adhesive 23 of the lower positioning block 2 can be peeled off, so that the lower positioning block 2 can be precisely attached to a relatively even lower flange 42 of the window frame 4. As a result, the upper and lower positioning blocks 1, 2 can be precisely mounted on any uneven upper and lower flanges 41, 42 of the window frame 4 on two sides of the vehicle.

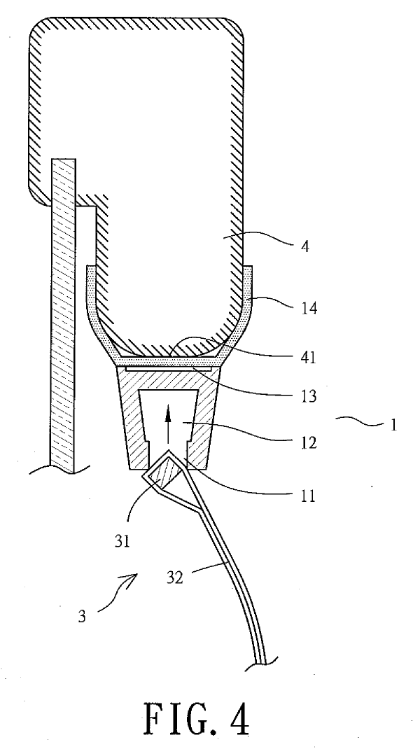

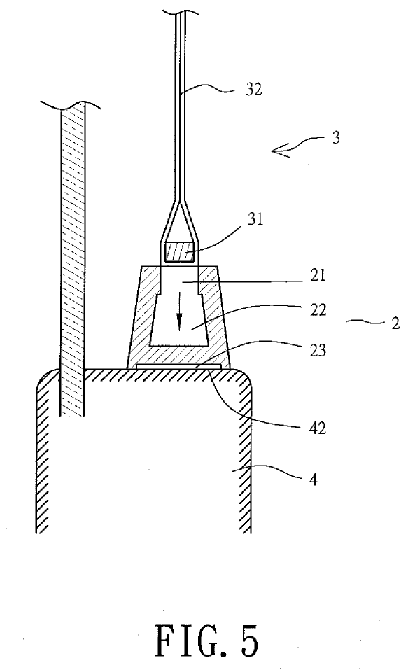

Referring now to FIGS. 4 and 5, when the sunshade 3 is held between the upper and lower positioning blocks 1, 2 mounted on the upper and lower flanges 41, 42 of the window frame 4 of the vehicle, the flexible member 31 wound in an end of the peripheral edge of the sunshade 3 is firstly inserted into the narrower opening 11 of the upper positioning block I along a side direction. Then, the flexible member 31 wound in another end of the peripheral edge of the sunshade 3 is directly inserted into the wider opening 21 of the lower positioning block 2. As a result, it is simple and easy to hold the sunshade 3 between the upper and lower positioning blocks 1, 2. Furthermore, when a vehicular window of the window frame 4 is shifted downward, it is still unnecessary to take off the sunshade 3 from the window frame 4. On the other hand, when a user wants to take off the sunshade 3, the user can manually pull the lower end of the sunshade 3 outward in relation to the wider opening 21 of the lower positioning block 2, so that the flexible member 31 wound in the peripheral edge of the sunshade 3 can be simply detached from the wider opening 21 due to the flexibility of the flexible member 31.

As described above, the upper and lower positioning blocks 1, 2 mounted on the window frame 4 of two sides of the vehicle can provide the following operational advantages:

(1) The upper and lower positioning blocks 1,2 for holding the sunshade 3 can be stably mounted on various different upper and lower flanges 41,42 of the window frames 4, so as to provide an operational flexibility.

(2) When holding the sunshade 3, the sunshade 3 can be precisely held and stably positioned by the opening 11 of the upper positioning block 1 and the opening 21 of the lower positioning block 2, wherein the opening 21 has a different width (or inner diameter) from that of the opening 11. Meanwhile, when the vehicular window of the window frame 4 is shifted downward, it is unnecessary to take off the sunshade 3 from the window frame 4.

(3) When the user wants to take off the sunshade 3, the user can manually pull the lower end of the sunshade 3 outward in relation to the wider opening 21 of the lower positioning block 2, so that the flexible member 31 wound in the peripheral edge of the sunshade 3 can be simply detached from the wider opening 21 due to the flexibility of the flexible member 31.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A positioning structure of a sunshade, comprising at least one positioning block and the sunshade having a peripheral edge wound with a flexible member therein, characterized in that:
positioning blocks includes at least one upper positioning block and at least one lower positioning block for holding the sunshade, wherein the upper positioning block has a surface attached to a flexible sheet via a double-sided adhesive and another surface formed with an opening providing a width permanently smaller than that of the flexible member wound in a peripheral edge of the sunshade, while the lower positioning block has a surface attached to a double-sided adhesive and another surface formed with an opening providing a width equal to or slightly greater than that of the flexible member wound therein; and
wherein the upper and lower positioning blocks are precisely mounted on an uneven upper flange and an uneven lower flange of a window frame on two sides of a vehicle for holding the sunshade therebetween; one side of the sunshade is inserted inclinedly into the opening of the upper positioning block along a side direction, and opposite side of the sunshade is directly inserted into the opening of the lower positioning block, so that the upper and lower positioning blocks provide an operational flexibility to stably hold the sunshade on various different window frames.
